(19) United States
(12) Patent Application Publication
(10) Pub. No.: US 2014/0280866 A1
(43) Pub. Date: Sep. 18, 2014

(54) SCALABLE LOAD BALANCING

(71) Applicants: Norman A. Lyon, Gatineau (CA); Roger J. Maitland, Woodlawn (CA)

(72) Inventors: Norman A. Lyon, Gatineau (CA); Roger J. Maitland, Woodlawn (CA)

(73) Assignee: Alcatel-Lucent Canada Inc., Ottawa (CA)

(21) Appl. No.: 13/803,133

(22) Filed: Mar. 14, 2013

(51) Int. Cl. H04L 12/70

(52) U.S. Cl. CPC H04L 47/125
USPC 709/224

(57) ABSTRACT

Various exemplary embodiments relate to a method and related network node including one or more of the following: receiving, by a load balancer, a plurality of metric values from a plurality of servers; calculating an average metric value based on the plurality of metric values; calculating a first error value based on the average metric value and a first metric value of the plurality of metric values; generating a first integral value by incorporating the first error value into a first previous integral value; and generating a first preference value for a first server of the plurality of servers based on the first integral value.

### TECHNICAL FIELD

Various exemplary embodiments disclosed herein relate generally to load balancing.

### BACKGROUND

Many client-server applications, including cloud-based applications, utilize one or more up-front load balancers to distribute incoming work requests among multiple application servers. The goal of such load balancers is generally to achieve balanced server utilization while minimizing server overload. To this end, load balancers generally receive work requests, select appropriate servers for processing the work requests according to some selection method, and forward the work requests to the selected servers.

### SUMMARY

A brief summary of various exemplary embodiments is presented below. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method performed by a load balancer for calculating a set of preferences for a plurality of servers, the method including: receiving, by a load balancer, a plurality of metric values from a plurality of servers; calculating an average metric value based on the plurality of metric values; calculating a first error value based on the average metric value and a first metric value of the plurality of metric values; generating a first integral value by incorporating the first error value into a first previous integral value; and generating a first preference value for a first server of the plurality of servers based on the first integral value.

Various exemplary embodiments relate to a load balancer including: a preference storage; and a processor configured to: receive a plurality of metric values from a plurality of servers, calculate an average metric value based on the plurality of metric values, calculate a first error value based on the average metric value and a first metric value of the plurality of metric values, generate a first integral value by incorporating the first error value into a first previous integral value, generate a first preference value for a first server of the plurality of servers based on the first integral value, and store the first preference value in the preference storage.

Various exemplary embodiments relate to a non-transitory machine-readable medium encoded with instructions for execution by a load balancer for calculating a set of preferences for a plurality of servers, the non-transitory machine-readable medium including: instructions for receiving, by a load balancer, a plurality of metric values from a plurality of servers; instructions for calculating an average metric value based on the plurality of metric values; instructions for calculating a first error value based on the average metric value and a first metric value of the plurality of metric values; instructions for instructions for generating a first integral value by incorporating the first error value into a first previous integral value; and instructions for generating a first preference value for a first server of the plurality of servers based on the first integral value.

Various embodiments additionally include receiving, at the load balancer, a work request; selecting a selected server of the plurality of servers according to a non-deterministic method based on a set of preferences that incorporates the first preference value; and transmitting the work request to the selected server.

Various embodiments are described wherein the non-deterministic method includes: generating a random number; identifying a server associated with the random number based on the set of preferences; and selecting the identified server as the selected server.

Various embodiments are described wherein the plurality of metric values includes at least one of: a processor utilization value, a queue depth value, and a memory usage value.

Various embodiments are described wherein the plurality of servers includes at least one of: a user equipment management unit, a radio network controller, and a cloud component.

Various embodiments are described wherein the first preference value is a cumulative value, wherein the first preference value is further generated based on at least one other preference value.

Various embodiments additionally include generating a proportional value based on the first error and a proportional constant, wherein generating the first preference value is further based on the proportional value.

Various embodiments additionally include periodically changing a value of the proportional constant.

Various embodiments are described wherein changing a value of the proportional constant includes: determining a previous direction of a previous change; determining whether the previous change resulted in increased performance; based on the previous change resulting in increased performance, changing the value of the proportional constant in the same direction as the previous direction; and based on the previous change resulting in decreased performance, changing the value of the proportional constant in the opposite direction from the previous direction.

Various embodiments additionally include: calculating a second error value based on the average metric value and a desired metric threshold; generating a second integral value by incorporating the second error value into a second previous integral value; and generating a second preference value for a call bucket based on the second integral value.

Various embodiments additionally include receiving, at the load balancer, a work request; selecting the call bucket as a selected server based on a set of preferences that incorporates the first preference value and the second preference value; based on selection of the call bucket, dropping the work request.

Various embodiments are described wherein generating a first preference value includes: calculating a preliminary preference value based on the first integral value; determining that the preliminary preference value exceeds a threshold; and based on the preliminary preference value exceeding the threshold, reducing the preliminary preference value to generate the first preference value.

Various embodiments are described wherein the threshold is set based on a known work-processing capability associated with the first server.

Various embodiments are described wherein the plurality of metric values is transmitted to the load balancer according to an assured transfer protocol.

Various embodiments additionally include sharing the first integral value with at least one other load balancer.

### BRIEF DESCRIPTION OF THE DRAWINGS

In order to better understand various exemplary embodiments, reference is made to the accompanying drawings, wherein:

FIG. 1 illustrates an exemplary network including a plurality of load balancers;

FIG. 2 illustrates an exemplary load balancer;

FIG. 3 illustrates an exemplary preference table;

FIG. 4 illustrates an exemplary feedback controller;

FIG. 5 illustrates an exemplary method for distributing a work request;

FIG. 6 illustrates an exemplary method for processing received metric values and calculating a server preference;

FIG. 7 illustrates an exemplary method for modifying a proportional constant; and

FIG. 8 illustrates an exemplary component diagram of a load balancer.

To facilitate understanding, identical reference numerals have been used to designate elements having substantially the same or similar structure or substantially the same or similar function.

### DETAILED DESCRIPTION

The description and drawings illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

The goal of load balancers becomes more difficult to achieve as redundant load balancers are added. Unless rigorous sharing of server selections between load balancers is employed, many arrangements of multiple load balancers that employ a deterministic server selection process may select the same server to process work requests, thereby sending a disproportionate amount of work and possibly overloading a single server. For example, open-loop round robin algorithms, while simple, may result in uneven load distribution, overload, or a reduction in nominal rated capacity in attempt to avoid overload.

Further complications arise where sessions are long-lived and have dramatic variation of load on the server. For example, where wireless data calls are being dispatched among radio network controllers, the calls can last many minutes with throughput that may range from zero to multiple megabits per second over the life of the call. Open-loop algorithms, because they do not utilize any feedback information, quite often send too many such calls to a single server. Other algorithms, such as the “turn down” algorithm, attempt to take these call assignments into account by generating a factor used to reduce server weights. This factor is based on rapidly changing dynamic information and is therefore difficult to share among all load balancers.

In view of the foregoing, there is a need for an improved load balancer and method of work distribution that scales well to multiple load balancers and meets the goals of a load balancer, as discussed above, in the presence of work requests having varying characteristics.

Referring now to the drawings, in which like numerals refer to like components or steps, there are disclosed broad aspects of various exemplary embodiments.

FIG. 1 illustrates an exemplary network 100 including a plurality of load balancers 130, 132, 134. The network 100 may include multiple clients 110, 112, 114 and multiple servers 120, 122, 124, 126. The clients 110, 112, 114 and servers 120, 122, 124, 126 may include any devices that engage in client-server relationships for various applications. In one exemplary embodiment, the clients 110, 112, 114 may each constitute user equipment (UE) such as mobile devices, which the servers 120, 122, 124, 126 may constitute UE management units (UMUs) implemented as part of a radio network controller (RNC) or other device. In various embodiments, the servers 120, 122, 124, 126 may constitute dedicated devices or may be provisioned within a cloud network. It will be understood that the clients 110, 112, 114 and servers 120, 122, 124, 126 may constitute any type of network devices such as, for example, personal computers, servers, blades, laptops, tablets, e-readers, mobile devices, routers, or switched. It will also be appreciated that alternative networks may include greater or fewer clients 110, 112, 114 or servers 120, 122, 124, 126 and that one or more intermediate devices, such as routers or switches, may provide connectivity between the various components of the network.

The clients 110, 112, 114 may periodically send work requests, such as requests for new data calls, for fulfillment by one or more of the servers 120, 122, 124, 126. The load balancers 130, 132, 134 may receive these work requests and distribute the work requests among the servers to ensure an even distribution of work and prevent server overload. In various embodiments, the load balancers 130, 132, 134 may be provisioned within the cloud and may be provisioned in a one-to-one correspondence with the client devices 110, 112, 114. It will be understood that various other arrangements may be used such as a one-to-many, many-to-one, or many-to-many correspondence.

As will be described in greater detail below, the load balancers 130, 132, 134 may implement one or more features to reach goals that are also scalable to larger numbers of load balancers. For example, the load balancers 130, 132, 134 may implement a stochastic server selection algorithm to reduce the likelihood that a large number of load balancers select the same server in the same time period, thereby overloading that load balancer. Further, the load balancers 130, 132, 134 may implement a feedback controller, such as a proportional-integral (PI) controller to inform the stochastic selection process. As yet another example, the load balancers 130, 132, 134 may implement a virtual server, or “call bucket,” with a preference for selection that increases as the system as a whole becomes overloaded. When the call bucket is selected for a work request, the load balancers 130, 132, 134 may simply discard the request, thereby helping to manage the overall commitment of the group of servers 120, 122, 124, 126. In various embodiments, discarding the request may involve various follow-on protocol or administrative actions such as, for example, notifying the requestor or updating a count.

FIG. 2 illustrates an exemplary load balancer 200. It will be understood that the various components of the load balancer 200 described herein may be implemented in hardware and/or software. For example, various components may together correspond to one or more processors configured to perform the functions described herein. The load balancer 200 may correspond to one or more of the load balancers 130, 132, 134 described above in connection with FIG. 1. The load balancer 200 may include a client interface 210, a server selector 220, a preference table 230, a server interface 240, an average metric calculator 250, a server error calculator 260, one or more feedback controllers 270, a call bucket error calculator 280, and a preference table generator 290.

The client interface 210 may be an interface including hardware and/or executable instructions encoded on a machine-readable storage medium configured to communicate with at least one client device, such as client devices 110, 112, 114 in FIG. 1. The client interface 210 may include one or more physical ports and may communicate according to one or more protocols, for example, TCP, IP, or Ethernet. In various embodiments, the client interface 210 may receive multiple work requests, such as requests for new data calls, from various client devices.

The server selector 220 may include hardware or executable instructions on a machine-readable storage medium configured to receive a work request via the client interface 210, select a server to process the work request, and forward the work request to the selected server via the server interface 240. In various embodiments, the server selector may implement a stochastic server selection process based on preferences for each server stored in the preference table 230. For example, the server selector may generate a random number and use the preference table to identify a server associated with the random number. As used herein, the term “random number” will be understood to carry the meaning known to those of skill in the art. For example, the random number may be generated using an arbitrary seed value and a mathematical function exhibiting statistical randomness. It will be understood that various alternative stochastic methods may be employed that take into account the preference table 230. Further, various deterministic methods, such as weighted round robin, may be used in conjunction with the preference table.

The preference table 230 may be a device that stores associations between various preference values and known servers capable of processing work requests. The preference table 230 may include a machine-readable storage medium such as read-only memory (ROM), random-access memory (RAM), magnetic disk storage media, optical storage media, flash-memory devices, and/or similar storage media. As will be explained below in connection with FIG. 3, the preference table may store a listing of servers and associated cumulative preference values. By storing cumulative preference values in the preference table 230, the server selection may easily use a random number to select a server by locating the first cumulative preference value in the list that exceeds the random number. It will be understood that other tables may alternatively be used, such as a table that stores base, non-cumulative preference values. As another alternative, the table may not store any preference values and, instead, store only a list of servers having a number of duplicate entries for each server that corresponds to the preference value.

The server interface 240 may be an interface including hardware and/or executable instructions encoded on a machine-readable storage medium configured to communicate with at least one server device, such as server devices 120, 122, 124, 126 in FIG. 1. The server interface 240 may include one or more physical ports and may communicate according to one or more protocols, for example, TCP, IP, or Ethernet. In various embodiments, the server interface 240 may transmit multiple work requests, such as requests for new data calls, to various server devices based on the instruction of the server selector 220. The server interface 240 may also receive reports of various performance metrics from the servers. For example, the server interface 240 may receive periodic reports on CPU usage, memory usage, or work queue depth. For example, the server interface may receive such reports approximately every second or simply from time-to-time as the server devices 120, 122, 124, 126 see fit to report usage. This information may be received according to an assured transfer protocol, such as TOTEM, thereby ensuring that all load balancers, including the load balancer 200, receive the same information. Specifically, when a server transmits the information according to such an assured transfer protocol, either all load balancers will receive the information or none of the load balancers will receive the information, thereby ensuring that all load balancers are operating on the same feedback. In various embodiments, the server interface 240 may constitute the same device, or part of the same device, as the client interface 210.

The average metric calculator 250 may include hardware or executable instructions on a machine-readable storage medium configured to receive and process metrics reported by the servers. Specifically, the average metric calculator may, for each metric type received, calculate an average for the metric across the servers. For example, upon receiving one or more values for server CPU utilization, the average metric calculator 250 may calculate an average CPU utilization across the servers. In some embodiments, the average metric calculator 250 may wait until new values are received from all servers or a predetermined number of servers or may proceed to update the average whenever any new metrics are reported.

In various embodiments, the average metric calculator 250 may exclude some servers from the average calculation. For example, as will be explained below, the feedback controllers 270 may maintain an integrator for each server. If any integrator exceeds predetermined limits, the integrator may be declared a “runaway integrator” and its corresponding server's metrics be excluded from the calculation of the present average. By declaring such runaway integrators, the detrimental effects of the Byzantine fault problem may be mitigated. It will be understood that servers associated with runaway integrators may still receive work requests and may still be associated with a preference value, as will be described in greater detail below.

The server error calculator 260 may include hardware or executable instructions on a machine-readable storage medium configured to calculate an error value for each of the servers to be used by the feedback controllers 270. As will be understood and explained below, various feedback controllers utilize an error signal. For example, the server error calculator 260 may calculate, for each specific server, the difference between the average metric calculated by the average metric calculator 250 and the metric reported by the specific server. The server error calculator 260 may then report the error to the appropriate feedback controller 270 for the server.

The feedback controllers 270 may include hardware or executable instructions on a machine-readable storage medium configured to calculate a preference value for a server based on an error signal. In various embodiments, each feedback controller 270 may implement a proportional-integral (PI) controller. It will be understood that various alternative feedback controllers may be implemented, such as proportional (P) controllers and proportional-integral-derivative (PID) controllers. An exemplary operation of the feedback controllers 270 will be described in greater detail below with respect to FIG. 4. The feedback controllers 270 may output a non-cumulative preference value for each of the servers to the preference table generator.

As mentioned above, various embodiments may implement a “call bucket” for use in disposing of some work requests. The call bucket may be associated with one of the feedback controllers 270. The feedback controller 270 may utilize a different error signal and thereby exhibit different behavior in terms of preference adaptation than the other feedback controllers 270. In various embodiments, it may be desirable that the preference for the call bucket remain set to zero until the total commitment of the system reaches a predetermined threshold deemed to be the limit. The call bucket error calculator 280 may include hardware or executable instructions on a machine-readable storage medium configured to calculate an error value in a different way from the server error calculator 260 and thereby achieve this different behavior. For example, the call bucket error calculator may calculate the difference between the average metric calculated by the average metric calculator 250 and a predetermined threshold. Thus, in this example, the error signal will be negative, or capped at zero, until the average metric surpasses the predetermined threshold.

The preference table generator 290 may include hardware or executable instructions on a machine-readable storage medium configured to generate, from the preferences reported by the feedback controllers 270, the values stored by the preference table 230. For example, the preference table generator 290 may generate cumulative preference values for storage in association with the various servers. In this manner, the operation of the server selector 220 may be influenced by the feedback controllers 270 and the metrics reported by the servers.

FIG. 3 illustrates an exemplary preference table 300. The exemplary preference table 300 may correspond to the values of the preference table 230 discussed above in connection with FIG. 2. As shown, the preference table 300 may include a server ID field 310 that stores an indication of the server to which each record corresponds, a base preference field 320 that stores the preference value calculated for the present server, and a cumulative preference field 320 that stores a cumulative preference value corresponding to the server. It will be understood that the preference table 300 may include greater or fewer records than those illustrated. Further, in various embodiments, the base preference field 320 may be omitted from the table and only the cumulative preference field 320 may be utilized for server selection.

Exemplary records 340, 350, 360, 370, 380, 390 correspond to servers 0, 1, 2, 3, 4, and 5 (the call bucket) respectively. As shown in exemplary record 330, server ID “0” is associated with both a base and cumulative preference value of “25.” As such, a server selector such as the server selector 220 of FIG. 2 may select server 0 for processing a work request if the server selector generates a random number that is less than 25. Exemplary record 340 shows that server ID “1” is associated with a base preference value of “10” and cumulative preference value of “35,” which is the sum of 10 and the cumulative preference value of the preceding record, record 340. As such, the server selector may select server 1 for processing a work request if the server selector generates a random number that is less than 35 but greater than or equal to 25. In this manner, exemplary conditions for the selection of servers 2, 3, and 4 will be apparent.

As shown in exemplary record 390, server ID “5” may be associated with the call bucket. As such, if a server selector were to select server 5 to process a work request, the work request may simply be dropped. As used herein, the term “dropping” will be understood to encompass actions such as rejecting the request by sending a rejection message to the requestor or simply ignoring the request without any notification to the requestor. As shown, the call bucket is associated with a base preference value of “0” and a cumulative preference value of “110,” which is the same cumulative preference value that is associated with the previous server, server 4. As such, a server selector may not select the call bucket for any random number because the server selector would select a lower server before selecting the call bucket for any random number that would otherwise be less than the call bucket's cumulative preference. For example, if the server selector generates the random number “109,” the server selector would select server 4 before having a chance to evaluate the call bucket. This scenario may indicate that the servers, on average, are currently operating below the call bucket threshold and, as such, no work requests are to be discarded.

FIG. 4 illustrates an exemplary feedback controller 400. The feedback controller 400 may correspond to one or more of the feedback controllers 270 described above in connection with FIG. 2. The feedback controller 400 may include an error receiver 410, an integrator 420, a preference calculator 430, and a proportional constant modifier 440.

The error receiver 410 may include hardware or executable instructions on a machine-readable storage medium configured to receive an error value used to drive the feedback controller 400. As described above, the error value may be calculated according to one of many methods. For example, if the feedback controller 400 is associated with a server, then the error value may be calculated according to the method described above with respect to the server error calculator 260. If the feedback controller 400 is associated with the call bucket, then the error value may be calculated according to the method described above with respect to the call bucket error calculator 280.

The integrator 420 may include hardware or executable instructions on a machine-readable storage medium configured to calculate an integral value based on the sequence of error values received by the error receiver 410. For example, in various embodiments, the integrator may store a running sum of error values. In some such embodiments, the integrator may add the product of the error value and an integral constant to the running sum. In various embodiments, multiple load balancers may be supported by sharing the integral value between the integrators 420 of the various load balancers. In such embodiments, the integrator 420 may be further configured to periodically transmit the integral value stored therein to at least one other load balancer or to receive an integral value from another load balancer and to use the received integral value going forward. For example, the integrator 420 may replace the stored integral value with the received integral value. In various embodiments, the integral value may be transmitted every few minutes.

The preference calculator 430 may include hardware or executable instructions on a machine-readable storage medium configured to calculate a preference value based on the integral maintained by the integrator 420 and the error value received by the error receiver 410. In various embodiments, the preference calculator 430 may implement the central function of a PI controller. For example, the preference calculator 430 may calculate a preliminary preference value by multiplying the error by a proportional constant adding the products to the current integral value. In various embodiments, the preference calculator 430 may proceed to perform further operations on this preliminary preference value. For example, if the preliminary preference value is a negative number, the preference calculator 430 may set, or “cap,” the value to zero. As another example, if the preliminary preference value exceeds some preset threshold, the preference calculator 430 may cap the value at the threshold or another value. In various embodiments, this threshold may be determined on a server-by-server basis and may be set based on the known capabilities of that server. By capping the maximum preference value, the Byzantine fault problem may be further mitigated. For example, because the preference for a server is not allowed to rise past the threshold, the effects of a server erroneously reporting excess capacity will be reduced. After generating a preference value, the preference calculator 430 may pass the preference value to another component, such as the preference table generator 290 of FIG. 2.

In various embodiments, it may be desirable to dynamically tune the proportional, integral, or other constants used by the feedback controller 400 rather than setting the constants to static values. For example, in the illustrated example, the feedback controller 400 may include a static integral constant but may dynamically tune the proportional constant. The proportional constant modifier 440 may include hardware or executable instructions on a machine-readable storage medium configured to modify the proportional constant over time. Specifically, the proportional constant modifier 440 may track various performance metrics, such as the range of metrics reported by the servers, and periodically (e.g., every 30 seconds) adjust the proportional constant up or down based on whether a performance increase was observed based on the previous adjustment. An exemplary method for changing the proportional constant will be discussed in greater detail below with respect to FIG. 7.

FIG. 5 illustrates an exemplary method 500 for distributing a work request. The method 500 may be implemented by one or more components of a load balancer 200 such as, for example, the server selector 220. Method 500 may begin in step 505 and proceed to step 510 where the load balancer 200 may receive a work request from a client device. Next, in step 515, the load balancer 200 may generate a random number between 0 and the maximum value stored in the preference table. In step 520, the load balancer 200 may select a server by locating an entry in the preference table associated with the random number. For example, the load balancer 200 may advance through a cumulative preference table until a cumulative preference value greater than the random number.

The load balancer 200 may then determine whether the selected server is the call bucket in step 525. If the load balancer 200 selected the call bucket, the load balancer 200 may simply drop the work request in step 530. Otherwise, the load balancer 200 may forward the work request to the selected server in step 535. The method 500 may then proceed to end in step 540.

FIG. 6 illustrates an exemplary method 600 for processing received metric values and calculating a server preference. The method 600 may be implemented by one or more components of a load balancer 200 such as, for example, one or more feedback controller 270. Exemplary method 600 is described as utilizing a CPU utilization value as a metric. Various modifications to support additional or alternative metrics will be apparent.

The method may begin in step 605 and proceed to step 610 where the load balancer 200 may receive one or more CPU utilization values, cpu, from the servers. It will be apparent that previous CPU utilization values may be used where one or more servers did not report new CPU utilization values. Next, in step 615, the load balancer 200 may calculate an average CPU utilization value, avg, from the CPU utilization values.

The load balancer 200 may begin iterating through the servers in step 620 by selecting a sever index, i, to process. Then, in step 625, the load balancer may determine whether the currently selected server, server i, corresponds to the call bucket. If so, the load balancer 200 may calculate the error, e, in step 630 by subtracting the preset threshold from the average CPU utilization value, avg. Otherwise, the load balancer 200 may calculate an error value, e, for server i in step 645 by subtracting the CPU utilization of server i, cpu[i], from the average CPU utilization value, avg. Next, in step 650, the load balancer 200 may update the running integral value by adding to the previous integral value for server i, I[i], the product of the error value, e, and an integral constant, Ki. The load balancer 200 may then, in step 655, calculate the preference value for server i, P[i], as the sum of the integral value for server i, I[i], and the product of the error, e, and a proportional constant, Kp.

The load balancer 200 may log various performance statistics in step 660 by, for example, updating values for a minimum and maximum CPU value observed. For example, if the CPU value for server i, cpu[i], is less than the current minimum CPU seen for this set of CPU values, cpu, the load balancer 200 may set the minimum CPU value to the value of cpu[i]. Likewise, if the CPU value for server i, cpu[i], is greater than the current maximum CPU seen for this set of CPU values, cpu, the load balancer 200 may set the maximum CPU value to the value of cpu[i]. Next, in step 665, the load balancer 200 may determine whether additional servers remain to be processed. If server i is not the last server to be processed, the method 600 may loop back to step 620.

After all servers, including the call bucket, have been evaluated by the loop of method 600, the method may proceed from step 665 to step 670, where the load balancer 200 may finish logging performance data. For example, the load balancer 200 may update a running sum of CPU utilization ranges by adding the difference between the maximum CPU value and minimum CPU value captured in the various executions of step 660. The load balancer 200 may also increment a running number of range samples. These values may be used by a proportional constant modifier, as will be described in greater detail with respect to FIG. 7. The method may then proceed to end in step 675.

It will be understood that the various proportional, integral, derivative, or other constants employed in the load balancer may be instantiated separately for each feedback controller or may be instantiated only once to be shared by all of the feedback controllers. In other words, the feedback controllers may each have unique constants, constants shared with other feedback controllers, or a combination thereof.

FIG. 7 illustrates an exemplary method 700 for modifying a proportional constant. The method 700 may be implemented by one or more components of a load balancer 200 such as, for example, one or more feedback controller 270. Exemplary method 600 is described as utilizing a CPU utilization value as a metric. Various modifications to support additional or alternative metrics will be apparent. Method 700 may be executed periodically such as, for example, every 30 seconds, to modify a proportional constant used by one or more feedback controllers.

The method may begin in step 705 and proceed to step 710 where the load balancer 200 may calculate an average CPU utilization range by, for example, dividing the sum of CPU ranges by the number of range samples captured in the previous execution of step 670 of method 600. Next, in step 715, the load balancer 200 may determine whether a performance increase was observed since the last time the proportional constant was modified by determining whether the average range calculated in step 710 is greater than a previous average range. It will be understood that various other methods of measuring system performance may be employed and various modifications for using such method will be apparent.

If the average range is greater than the previous average range, thereby indicating decreased performance, the load balancer 200 may, in step 720, reverse the direction of constant modification. Thus, for example, if the proportional constant was previously increased, the direction will be changed to “down.” If the average range is less than the previous average range, thereby indicating increased performance, the load balancer 200 may skip ahead to step 725.

In step 725, the load balancer 200 may determine whether the current modification direction is “up.” If so, the load balancer 200 may increase the proportional constant, Kp, in step 730. The proportional constant may be increased in any known manner such as, for example, incrementing the constant, adding a predetermined value to the constant, doubling the constant, multiplying the constant by a predetermined value, or selecting a next highest value in a predetermined sequence of values. On the other hand, if the current modification direction is “down,” the load balancer 200 may decrease the proportional constant, Kp, in step 735. The proportional constant may be decreased in any known manner such as, for example, decrementing the constant, subtracting a predetermined value from the constant, halving the constant, dividing the constant by a predetermined value, or selecting a next lowest value in a predetermined sequence of values.

The load balancer 200 may then, in step 740, save the average range for use in the next execution of method 700 as the previous average range. The load balancer 200 may also reset the sum of CPU ranges and sample number to zero in step 745. The method 700 may then proceed to end in step 750.

FIG. 8 illustrates an exemplary component diagram of a load balancer 800. The load balancer 800 may correspond to one or more of load balancers 130, 132, 134 or load balancer 200. The load balancer 800 may include a processor 810, data storage 820, and an input/output (I/O) interface 830.

The processor 810 may control the operation of the load balancer 800 and cooperate with the data storage 820 and the I/O interface 830, via a system bus. As used herein, the term “processor” will be understood to encompass a variety of devices such as microprocessors, field-programmable gate arrays (FPGAs), application-specific integrated circuits (ASICs), and other similar processing devices.

The data storage 820 may store program data such as various programs useful in implementing the functions described above. For example, the data storage 820 may store work distribution instructions 821 for performing method 500 or another method suitable to distribute work requests to various servers. The data storage 820 may also store preference table generation instructions for performing method 600 or another method suitable to generate preference values for multiple servers. Additionally, the data storage 820 may store proportional constant modification instructions for performing method 700 or another method suitable for tuning a proportional constant or other constants.

The data storage 820 may also store various runtime values. For example, the data storage 820 may store feedback controller values 827 such as various constant values, integrator values, error values, threshold values, and any other values used by the feedback controllers. The data storage 820 may also store the preference table 829 used by the work distribution instructions 821 for selecting a server to process a work request.

The I/O interface 830 may cooperate with the processor 810 to support communications over one or more communication channels. For example, the I/O interface 830 may include a user interface, such as a keyboard and monitor, and/or a network interface, such as one or more Ethernet ports.

In some embodiments, the processor 810 may include resources such as processors/CPU cores, the I/O interface 830 may include any suitable network interfaces, or the data storage 820 may include memory or storage devices such as magnetic storage, flash memory, random access memory, read only memory, or any other suitable memory or storage device. Moreover the load balancer 800 may be any suitable physical hardware configuration such as: one or more server(s), blades consisting of components such as processor, memory, network interfaces or storage devices. In some of these embodiments, the load balancer 800 may include cloud network resources that are remote from each other and may be implemented as a virtual machine.

According to the foregoing, various embodiments enable distribution of work requests in a way that easily scales to multiple load balancers. By employing a stochastic server selection method driven by feedback controllers, work may be distributed by multiple load balancers among multiple servers without unknowingly overloading the server that currently has the least amount of work. Additional benefits will be apparent in view of the foregoing.

It should be apparent from the foregoing description that various exemplary embodiments of the invention may be implemented in hardware or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a tangible and non-transitory machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be effected while remaining within the spirit and scope of the invention. Accordingly, the foregoing disclosure, description, and figures are for illustrative purposes only and do not in any way limit the invention, which is defined only by the claims.

What is claimed is:

1. A method performed by a load balancer for calculating a set of preferences for a plurality of servers, the method comprising:
receiving, by a load balancer, a plurality of metric values from a plurality of servers;
calculating an average metric value based on the plurality of metric values;
calculating a first error value based on the average metric value and a first metric value of the plurality of metric values;
generating a first integral value by incorporating the first error value into a first previous integral value; and
generating a first preference value for a first server of the plurality of servers based on the first integral value.

2. The method of claim 1, further comprising:
receiving, at the load balancer, a work request;
selecting a selected server of the plurality of servers according to a non-deterministic method based on a set of preferences that incorporates the first preference value; and
transmitting the work request to the selected server.

3. The method of claim 2, wherein the non-deterministic method comprises:
generating a random number;
identifying a server associated with the random number based on the set of preferences; and
selecting the identified server as the selected server.

4. The method of claim 1, wherein the plurality of metric values comprises at least one of: a processor utilization value, a queue depth value, and a memory usage value.

5. The method of claim 1, wherein the plurality of servers comprise at least one of: a user equipment management unit, a radio network controller, and a cloud component.

6. The method of claim 1, wherein the first preference value is a cumulative value, wherein the first preference value is further generated based on at least one other preference value.

7. The method of claim 1, further comprising:
generating a proportional value based on the first error and a proportional constant,
wherein generating the first preference value is further based on the proportional value.

8. The method of claim 7, further comprising:
periodically changing a value of the proportional constant.

9. The method of claim 8, wherein changing a value of the proportional constant comprises:
determining a previous direction of a previous change;
determining whether the previous change resulted in increased performance;
changing, based on the previous change resulting in increased performance, the value of the proportional constant in the same direction as the previous direction; and
changing, based on the previous change resulting in decreased performance, the value of the proportional constant in the opposite direction from the previous direction.

10. The method of claim 1, further comprising:
calculating a second error value based on the average metric value and a desired metric threshold;
generating a second integral value by incorporating the second error value into a second previous integral value; and
generating a second preference value for a call bucket based on the second integral value.

11. The method of claim 10, further comprising:
receiving, at the load balancer, a work request;
selecting the call bucket as a selected server based on a set of preferences that incorporates the first preference value and the second preference value; and
dropping the work request based on selection of the call bucket.

12. The method of claim 1, wherein generating a first preference value comprises:
calculating a preliminary preference value based on the first integral value;
determining that the preliminary preference value exceeds a threshold; and
based on the preliminary preference value exceeding the threshold, reducing the preliminary preference value to generate the first preference value.

13. The method of claim 12, wherein the threshold is set based on a known work-processing capability associated with the first server.

14. The method of claim 1, wherein the plurality of metric values are transmitted to the load balancer according to an assured transfer protocol.

15. The method of claim 1, further comprising sharing the first integral value with at least one other load balancer.

16. A load balancer comprising:
a preference storage; and
a processor configured to:
receive a plurality of metric values from a plurality of servers,
calculate an average metric value based on the plurality of metric values,
calculate a first error value based on the average metric value and a first metric value of the plurality of metric values,
generate a first integral value by incorporating the first error value into a first previous integral value,
generate a first preference value for a first server of the plurality of servers based on the first integral value, and
store the first preference value in the preference storage.

17. The load balancer of claim 16, wherein the processor is further configured to:
receive a work request;
select a selected server of the plurality of servers according to a non-deterministic method based on a set of preferences that incorporates the first preference value; and
transmit the work request to the selected server.

18. The load balancer of claim 17, wherein the non-deterministic method comprises:
generating a random number;
identifying a server associated with the random number based on the set of preferences; and
selecting the identified server as the selected server.

19. The load balancer of claim 16, wherein the plurality of metric values comprises at least one of: a processor utilization value, a queue depth value, and a memory usage value.

20. The load balancer of claim 16, wherein the plurality of servers comprise at least one of: a user equipment management unit, a radio network controller, and a cloud component.

21. The load balancer of claim 16, wherein the first preference value is a cumulative value, wherein the first preference value is further generated based on at least one other preference value.

22. The load balancer of claim 16, wherein the processor is further configured to:
generate a proportional value based on the first error and a proportional constant,
wherein generating the first preference value is further based on the proportional value.

23. The load balancer of claim 22, wherein the processor is further configured to:
periodically change a value of the proportional constant.

24. The load balancer of claim 23, wherein, in changing a value of the proportional constant, the processor is configured to:
determine a previous direction of a previous change;
determine whether the previous change resulted in increased performance;
change, based on the previous change resulting in increased performance, the value of the proportional constant in the same direction as the previous direction; and
change, based on the previous change resulting in decreased performance, the value of the proportional constant in the opposite direction from the previous direction.

25. The load balancer of claim 16, wherein the processor is further configured to:
calculate a second error value based on the average metric value and a desired metric threshold;
generate a second integral value by incorporating the second error value into a second previous integral value; and
generate a second preference value for a call bucket based on the second integral value.

26. The load balancer of claim 25, wherein the processor is further configured to:
receive a work request;
select the call bucket as a selected server based on a set of preferences that incorporates the first preference value and the second preference value; and
drop the work request based on selection of the call bucket.

27. The load balancer of claim 16, wherein, in generating a first preference value, the processor is configured to:
calculate a preliminary preference value based on the first integral value;
determine that the preliminary preference value exceeds a threshold; and
based on the preliminary preference value exceeding the threshold, reduce the preliminary preference value to generate the first preference value.

28. The load balancer of claim 27, wherein the threshold is set based on a known work-processing capability associated with the first server.

29. The load balancer of claim 16, wherein the plurality of metric values are transmitted to the load balancer according to an assured transfer protocol.

30. The load balancer of claim 16, wherein the processor is further configured to share the first integral value with at least one other load balancer.

31. A non-transitory machine-readable medium encoded with instructions for execution by a load balancer for calculating a set of preferences for a plurality of servers, the non-transitory machine-readable medium comprising:
instructions for receiving, by a load balancer, a plurality of metric values from a plurality of servers;
instructions for calculating an average metric value based on the plurality of metric values;
instructions for calculating a first error value based on the average metric value and a first metric value of the plurality of metric values;
instructions for generating a first integral value by incorporating the first error value into a first previous integral value; and
instructions for generating a first preference value for a first server of the plurality of servers based on the first integral value.

32. The non-transitory machine-readable medium of claim 31, further comprising:
instructions for receiving, at the load balancer, a work request;
instructions for selecting a selected server of the plurality of servers according to a non-deterministic method based on a set of preferences that incorporates the first preference value; and
instructions for transmitting the work request to the selected server.

33. The non-transitory machine-readable medium of claim 32, wherein the non-deterministic method comprises:
generating a random number;
identifying a server associated with the random number based on the set of preferences; and
selecting the identified server as the selected server.

34. The non-transitory machine-readable medium of claim 31, wherein the plurality of metric values comprises at least one of: a processor utilization value, a queue depth value, and a memory usage value.

35. The non-transitory machine-readable medium of claim 31, wherein the plurality of servers comprise at least one of: a user equipment management unit, a radio network controller, and a cloud component.

36. The non-transitory machine-readable medium of claim 31, wherein the first preference value is a cumulative value, wherein the first preference value is further generated based on at least one other preference value.

37. The non-transitory machine-readable medium of claim 31, further comprising:
instructions for generating a proportional value based on the first error and a proportional constant,
wherein generating the first preference value is further based on the proportional value.

38. The non-transitory machine-readable medium of claim 37, further comprising:
instructions for periodically changing a value of the proportional constant.

39. The non-transitory machine-readable medium of claim 38, wherein changing a value of the proportional constant comprises:
instructions for determining a previous direction of a previous change;
instructions for determining whether the previous change resulted in increased performance;
instructions for changing, based on the previous change resulting in increased performance, the value of the proportional constant in the same direction as the previous direction; and
instructions for changing, based on the previous change resulting in decreased performance, the value of the proportional constant in the opposite direction from the previous direction.

40. The non-transitory machine-readable medium of claim 31, further comprising:
instructions for calculating a second error value based on the average metric value and a desired metric threshold;
instructions for generating a second integral value by incorporating the second error value into a second previous integral value; and
instructions for generating a second preference value for a call bucket based on the second integral value.

41. The non-transitory machine-readable medium of claim 40, further comprising:
instructions for receiving, at the load balancer, a work request;
instructions for selecting the call bucket as a selected server based on a set of preferences that incorporates the first preference value and the second preference value;
instructions for dropping the work request based on selection of the call bucket.

42. The non-transitory machine-readable medium of claim 31, wherein the instructions for generating a first preference value comprise:
instructions for calculating a preliminary preference value based on the first integral value;
instructions for determining that the preliminary preference value exceeds a threshold; and
instructions for, based on the preliminary preference value exceeding the threshold, reducing the preliminary preference value to generate the first preference value.

43. The non-transitory machine-readable medium of claim 42, wherein the threshold is set based on a known work-processing capability associated with the first server.

44. The non-transitory machine-readable medium of claim 31, wherein the plurality of metric values are transmitted to the load balancer according to an assured transfer protocol.

45. The non-transitory machine-readable medium of claim 31, further comprising instructions for sharing the first integral value with at least one other load balancer.
